(19) United States
(12) Patent Application Publication
(10) Pub. No.: US 2023/0228377 A1
(43) Pub. Date: Jul. 20, 2023

(54) TANK

(71) Applicant: TOYOTA JIDOSHA KABUSHIKI KAISHA, Toyota-shi (JP)

(72) Inventor: Yasuhiro IIDA, Toyota-shi (JP)

(73) Assignee: TOYOTA JIDOSHA KABUSHIKI KAISHA, Toyota-shi (JP)

(21) Appl. No.: 18/155,200

(22) Filed: Jan. 17, 2023

(30) Foreign Application Priority Data
Jan. 18, 2022 (JP) 2022-005772

(51) Int. Cl. F17C 1/08

(52) U.S. Cl. CPC F17C 1/08; F17C 2203/0604; F17C 2201/0109; F17C 2203/012; F17C 2203/0621; F17C 2209/2163

(57) ABSTRACT

A tank comprises: a liner including a circular cylindrical body part having a center axis and a dome part placed at each of opposite ends of the body part; and a reinforcing layer placed on the liner and containing fiber. The reinforcing layer includes a hoop layer placed on the body part and a helical layer placed across an area on the hoop layer and on the dome part. The hoop layer includes a hoop body layer and a hoop end layer connected to the hoop body layer and located at an end portion of the hoop body layer in an axis direction along the center axis. The hoop end layer has a shape projecting externally further in a radial direction of the body part than the hoop body layer, and includes an apex portion located at the outermost position in the radial direction and a tilted surface extending from the apex portion toward an outer surface of the dome part and having a shape conforming to the shape of the outer surface.

### CROSS REFERENCE TO RELATED APPLICATIONS

The present application claims priority from Japanese patent application No.2022-5772 filed on Jan. 18, 2022, the disclosure of which is hereby incorporated in its entirety by reference into the present application.

### BACKGROUND

### Field

The present disclosure relates to a technique relating to a tank for storing a fluid therein.

### Related Art

A tank conventionally known stores therein fuel used for natural gas cars, fuel cell cars, etc. (Japanese Patent Application Publication No. 2016-223569). The conventional tank includes a liner and a reinforcing layer placed on the liner. The reinforcing layer includes a sheet layer (also called a hoop layer) placed on a straight part of the liner, and a helical layer placed on the sheet layer and on a dome part of the liner. The helical layer is formed by helical winding of a fiber on the sheet layer and on the dome part. Opposite end portions of the sheet layer is processed into shapes conforming to an outer surface of the dome part.

The helical winding for forming the helical layer is performed while tension is applied to the fiber. According to the conventional technique, however, it is impossible in some cases to apply intended tension on the opposite end portions of the sheet layer. In such cases, increasing the strength of the tank may be impossible due to a clearance formed between the sheet layer and the helical layer.

### SUMMARY

According to a first aspect of the present disclosure, a tank for storing a fluid therein is provided. The tank comprises: a liner including a circular cylindrical body part having a center axis and a dome part placed at each of opposite ends of the body part; and a reinforcing layer placed on the liner and containing fiber. The reinforcing layer includes a hoop layer placed on the body part and a helical layer placed across an area on the hoop layer and on the dome part. The hoop layer includes a hoop body layer and a hoop end layer connected to the hoop body layer and located at an end portion in an axis direction along the center axis. The hoop end layer has a shape projecting externally further in a radial direction of the body part than the hoop body layer, and includes an apex portion located at the outermost position in the radial direction and a tilted surface extending from the apex portion toward an outer surface of the dome part and having a shape conforming to the shape of the outer surface.

### BRIEF DESCRIPTION OF THE DRAWINGS

FIG. 1 is a sectional view of a tank;

FIG. 2 is a view for explaining the tank further;

FIG. 3 is a process view showing a method of manufacturing the tank;

FIG. 4 is an explanatory view of a step P10;

FIG. 5 is a sectional view of a hoop layer before processing from which a mandrel was extracted by an extraction step;

FIG. 6 is a sectional view of a hoop layer before placement;

FIG. 7 is a schematic view showing a state where a hoop layer is formed on a body part;

FIG. 8 is a view for explaining low-angle helical winding;

FIG. 9 is a view for explaining high-angle helical winding;

FIG. 10 is a view for explaining a tank of a reference example; and

FIG. 11 is a view for explaining a helical layer forming step further.

### DETAILED DESCRIPTION

### A. Embodiment

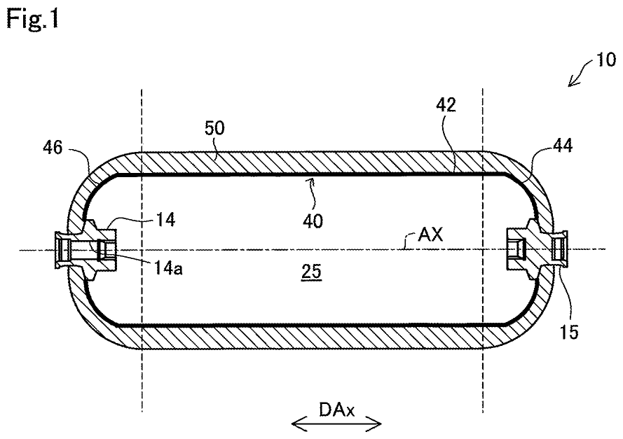

FIG. 1 is a sectional view of a tank 10 according the present embodiment. FIG. 1 shows a section (predetermined section) defined by cutting the tank 10 along a plane passing through a center axis AX of a body part 42 of the tank 10 and parallel to the center axis AX. The tank 10 is used for storing a high-pressure fluid therein. In the present embodiment, the tank 10 stores high-pressure fuel gas used for fuel cell cars, for example. The tank 10 includes a liner 40, a reinforcing layer 50 placed on the liner 40, a first ferrule part 14, and a second ferrule part 15. The first ferrule part 14 includes an opening 14a for forming communication between the interior and exterior of the tank 10. The second ferrule part 15 does not include the opening 14a.

The liner 40 is a hollow container in which a storage chamber 25 is formed for storing a fluid therein. The liner 40 is made of resin with gas barrier properties such as polyamide resin, for example. The liner 40 may be made of metal instead of the resin. The liner 40 includes the circular cylindrical body part 42 having the center axis AX, and dome parts 44 and 46 in a pair placed at opposite ends of the body part 42. One of the dome parts 44 and 46 in a pair is also called a first dome part 44, and the other is also called a second dome part 46. The first dome part 44 is connected to one end portion of the body part 42 in an axis direction DAx along the center axis AX. The second dome part 46 is connected to the other end portion of the body part 42 in the axis direction DAx. Each of the first dome part 44 and the second dome part 46 has a dome shape having an outer diameter reduced with a greater distance from the body part 42 in the axis direction DAx.

The reinforcing layer 50 is a layer for reinforcing the liner 40. The reinforcing layer 50 covers an outer surface of the liner 40. The reinforcing layer 50 contains a fiber. In the present embodiment, the reinforcing layer 50 is composed of a carbon fiber bundle impregnated in advance with thermosetting resin such as epoxy resin.

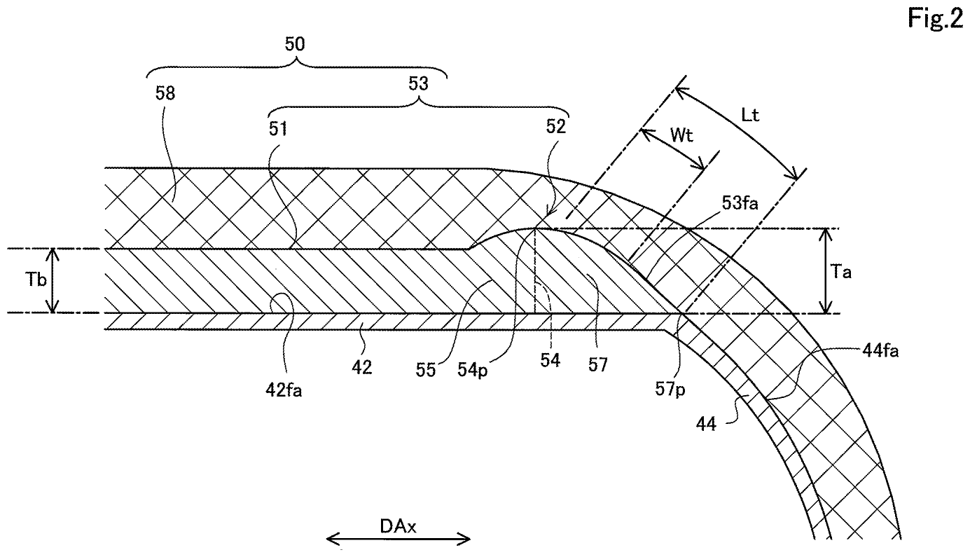

FIG. 2 is a view for explaining the tank 10 further. FIG. 2 schematically shows a region of the tank 10 in FIG. 1 covering a boundary between the body part 42 and the first dome part 44. A region covering a boundary between the body part 42 and the second dome part 46 has a corresponding structure. For this reason, a detailed configuration of the tank 10 will be described below using the region covering the boundary between the body part 42 and the first dome part 44.

The reinforcing layer 50 includes a hoop layer 53 placed on the body part 42, and a helical layer 58 placed across an area on the hoop layer 53 and on the dome part 44. A winding direction of a fiber to form the hoop layer 53 is a direction along a peripheral direction of the body part 42. Specifically, the winding direction of the fiber of the hoop layer 53 and the axis direction DAx form an angle that is approximately 90°. In the present embodiment, the hoop layer 53 is formed by preparing a cylindrical member by winding a sheet-like fiber impregnated with thermosetting resin on a member different from the liner 40, and placing the cylindrical member at the body part 42 of the liner 40. A method of forming the hoop layer 53 will be described later in detail. The helical layer 58 is formed by winding a fiber bundle impregnated with thermosetting resin in such a manner as to cover the hoop layer 53, the first dome part 44, and the second dome part 46 while tension set in advance is applied to the fiber bundle. The helical layer 58 is formed by winding the fiber bundle repeatedly on the tank 10 using at least one of low-angle helical winding and high-angle helical winding. A method of forming the helical layer 58 will be described later in detail.

The hoop layer 53 includes a hoop body layer 51 having a constant thickness and a hoop end layer 52. In a radial direction of the body part 42, a distance between an outer surface 42fa of the body part 42 and an outer surface of the hoop body layer 51, namely, the thickness of the hoop body layer 51 is defined as a thickness Tb. The hoop end layer 52 includes two layers located at opposite end portions of the hoop body layer 51 in the axis direction DAx. While the description herein is intended for one hoop end layer 52 belonging to the two hoop end layers 52 at the opposite end portions, the same configuration is also applied to the other hoop end layer 52. The hoop end layer 52 is connected to the hoop body layer 51 and located at an end portion of the hoop layer 53 in the axis direction DAx.

The hoop end layer 52 has a convex shape projecting externally further in the radial direction of the body part 42 than the hoop body layer 51. More specifically, the hoop end layer 52 includes an apex portion 54p located at the outermost position of the hoop end layer 52 in the radial direction, specifically, an intermediate portion 54 of the greatest thickness of the hoop end layer 52, a hoop base end portion 55 connecting the intermediate portion 54 and the hoop body layer 51, and a hoop tip portion 57 located on the opposite side of the hoop base end portion 55 across the intermediate portion 54 in the axis direction DAx. The hoop base end portion 55 has a thickness that is gradually increased further with a shorter distance from the hoop body layer 51 toward the intermediate portion 54 in the axis direction DAx. An outer surface of the hoop base end portion 55 is a tilted surface tilted from the axis direction DAx and having a curved surface shape, for example. The hoop tip portion 57 has a thickness that is gradually reduced further with a greater distance from the intermediate portion 54, namely, with a shorter distance to the dome part (here, the first dome part 44) in the axis direction DAx. A tilted surface 53fa corresponding to an outer surface of the hoop tip portion 57 extends from the apex portion 54p toward an outer surface 44fa of the dome part (here, the first dome part 44), and is tilted from the axis direction DAx. A boundary between the tilted surface 53fa and the outer surface 44fa forms a smooth curved surface without generating a step height. Specifically, the tilted surface 53fa has a shape formed by extending the outer surface 44fa in such a manner as to be defined in the same way as the shape of the outer surface 44fa, and has a curved surface shape conforming to the shape of the outer surface 44fa. In the present embodiment, the tilted surface 53fa and the outer surface 44fa of the dome part (here, the first dome part 44) on the same side relative to the axis direction DAx form an isotonic curved surface. In a certain section of the tank 10 shown in FIG. 2, a distance Lt along the tilted surface 53fa is preferably equal to or greater than a width Wt of the fiber bundle used for forming the helical layer 58. The distance Lt is a distance determined along the tilted surface 53fa from the apex portion 54p to an end portion 57p of the tilted surface 53fa adjacent to the dome part (here, the first dome part 44). With this configuration, it is possible to place the fiber bundle along its entire width on the tilted surface 53fa during helical winding, allowing a greater amount of pressing force responsive to intended tension on the fiber bundle to be applied to the tilted surface 53fa. This achieves an increased degree of tight contact between the helical layer 58 and the hoop end layer 52.

Preferably, a maximum thickness of the hoop end layer 52, namely, a distance Ta between the apex portion 54p and the outer surface 42fa of the body part 42 in the radial direction of the body part 42 is equal to or greater than 1.05 times the thickness Tb of the hoop body layer 51. This allows the tilted surface 53fa to be tilted more largely from the axis direction DAx to a degree by which distribution of force of pressing the fiber bundle toward the hoop end layer 52 is suppressed during helical winding. The distance Ta is also preferably equal to or less than 1.10 times the thickness Tb. This makes it possible to restrict a degree of external projection of the hoop end layer 52 in the radial direction, thereby achieving reduction in the occurrence of strain on a fiber bundle 80 forming the helical layer 58.

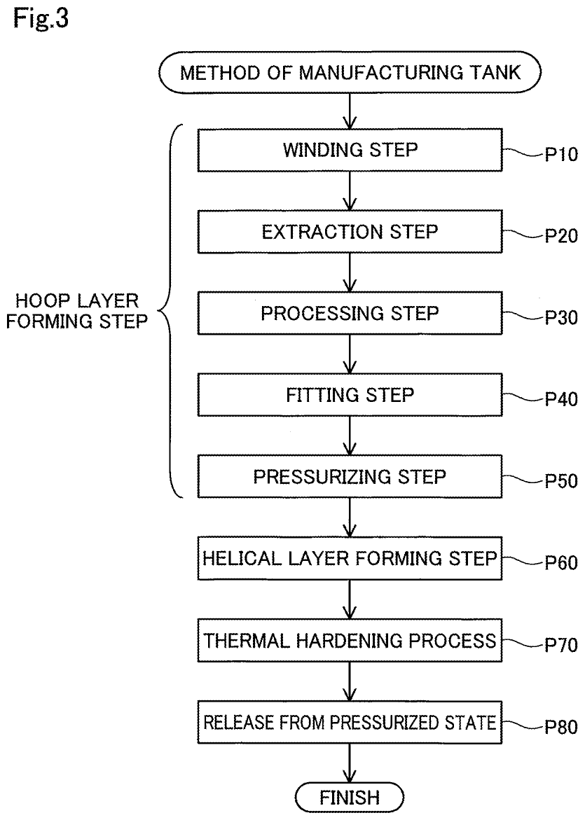

FIG. 3 is a process view showing a method of manufacturing the tank 10. According to the manufacturing method of the present embodiment, after a hoop layer forming step is performed in which the hoop layer 53 is placed on the liner 40, a helical layer forming step is performed in which the helical layer 58 is placed on the hoop layer 53 and on the dome parts 44 and 46.

In the hoop layer forming step, a winding step is performed first in which a sheet fiber is wound on a mandrel (cored bar) having higher stiffness than the liner 40 (step P10).

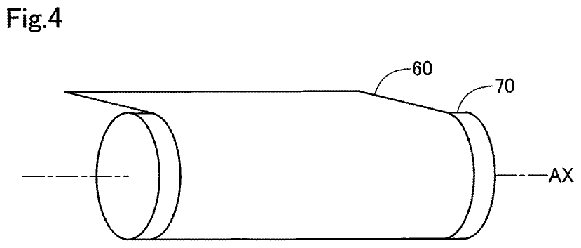

FIG. 4 is an explanatory view of the step P10. In the step P10, a mandrel 70 is prepared first. The mandrel 70 is a member different from the liner 40 and to become a mold for a hoop layer 62 before processing. The mandrel 70 has a circular columnar shape formed by using stainless steel or metal such as iron or copper, for example. The mandrel 70 has an outer diameter slightly larger (by about 0.5 mm, for example) than that of the body part 42 of the liner 40. A length of the mandrel 70 along the axis AX is larger than the length of the body part 42 of the liner 40. In the present embodiment, the stiffness of the mandrel 70 is higher than that of the liner 40.

After the mandrel 70 is prepared, a sheet fiber 60 impregnated with thermosetting resin is wound several times in a peripheral direction of the mandrel 70 using a sheet winding method (hereinafter called an “SW method”), thereby completing the hoop layer 62 before processing. In the present embodiment, the sheet fiber 60 has a width same as the length of the body part 42 of the liner 40 in the axis direction DAx. During winding of the sheet fiber 60 on the mandrel 70, tension set in advance is applied to the sheet fiber 60. According to the SW method, tension per unit width to be applied to the sheet fiber 60 is about twice as high as tension to be applied to a fiber bundle by a common filament winding method (hereinafter called an “FW method”), for example.

Subsequent to completion of formation of the hoop layer 62 before processing, a step of extracting the mandrel 70 from the hoop layer 62 before processing is performed (a step P20 in FIG. 2). The step P20 is also called an extraction step.

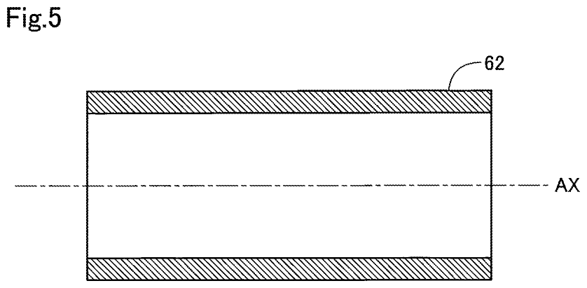

FIG. 5 is a sectional view of the hoop layer 62 before processing from which the mandrel 70 was extracted by the extraction step. As shown in FIG. 5, after extraction of the mandrel 70, the hoop layer 62 before processing has a circular cylindrical shape.

After implementation of the extraction step, the hoop layer 62 before processing is processed to form a hoop layer 63 before placement as a cylindrical member including the hoop body layer 51 and the hoop end layer 52 (a step P30 in FIG. 2). The step P30 is also called a processing step.

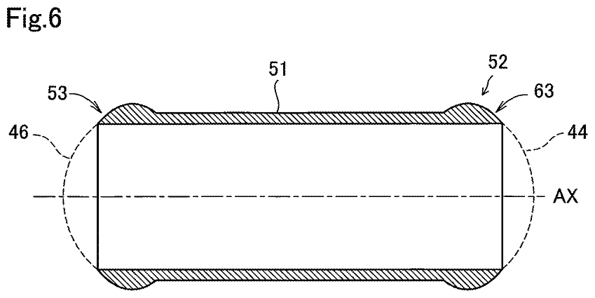

FIG. 6 is a sectional view of the hoop layer 63 before placement. In the processing step, the hoop layer 62 before processing is processed by cutting or grinding into a shape conforming to the shape of the hoop layer 53.

After implementation of the processing step, a step of fitting the liner 40 into the hoop layer 63 before placement is performed (a step P40 in FIG. 2). The step P40 is also called a fitting step. As a result of implementation of the fitting step, the hoop layer 63 before placement is placed on the body part 42 of the liner 40 to become the hoop layer 53.

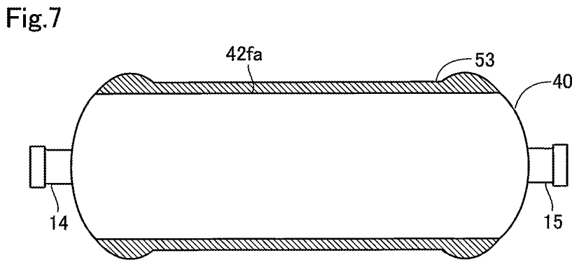

FIG. 7 is a schematic view showing a state where the hoop layer 53 is formed on the body part 42 of the liner 40 by the fitting step. In a step performed after implementation of the fitting step, the interior of the liner 40 is pressurized through the first ferrule part 14 to form tight contact of the outer surface 42fa of the body part 42 of the liner 40 with an inner surface of the hoop layer 53 (a step P50 in FIG. 2). The step P50 is also called a pressurizing step.

After implementation of the pressurizing step, with the interior of the liner 40 kept in the pressurized state, a helical layer forming step is performed (a step P60). In the helical layer forming step, a fiber bundle impregnated with thermosetting resin is first wound several times by helical winding on the liner 40 using the FW method to form the helical layer 58 composed of a plurality of layers. The helical winding is performed using at least one of high-angle helical winding and low-angle helical winding. In the present embodiment, the helical layer 58 is formed using high-angle helical winding and low-angle helical winding in combination.

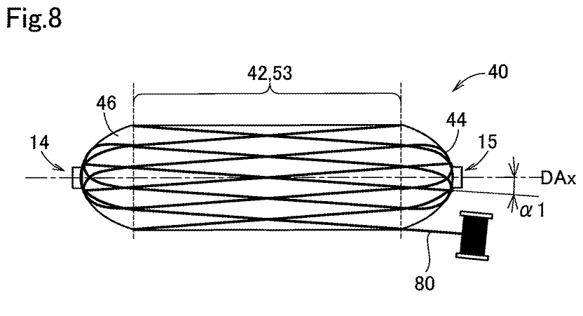

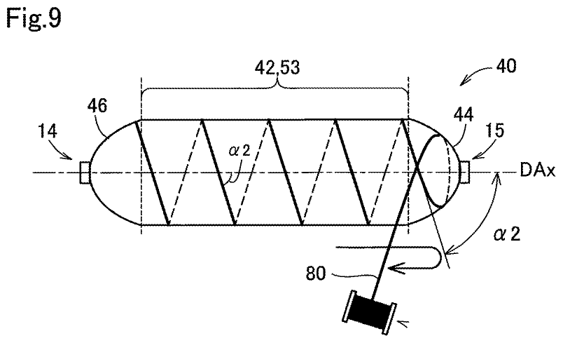

FIG. 8 is a view for explaining the low-angle helical winding. FIG. 9 is a view for explaining the high-angle helical winding. As shown in FIG. 8, according to the low-angle helical winding, the fiber bundle 80 is wound repeatedly in a spiral pattern in such a manner as to stretch between the two dome parts 44 and 46. In a layer formed by the low-angle helical winding, an angle α1 formed between a winding direction of the fiber bundle 80 and the axis direction DAx is any angle in an exemplary range from 5 to 40° (for example, 15°).

As shown in FIG. 9, in a layer formed by the high-angle helical winding, an angle α2 formed between a winding direction of the fiber bundle 80 and the axis direction DAx is larger than the angle al determined by the low-angle helical winding. The angle α2 is any angle in an exemplary range from 65° to 87° (for example, 80°).

After implementation of the helical layer forming step, a thermal hardening process is performed for hardening the hoop layer 53 and the helical layer 58 integrally by applying heat (a step P70 in FIG. 2). After implementation of the thermal hardening process, the liner 40 is released from the pressurized state (a step P80). As a result of a series of the steps described above, formation of the tank 10 is completed.

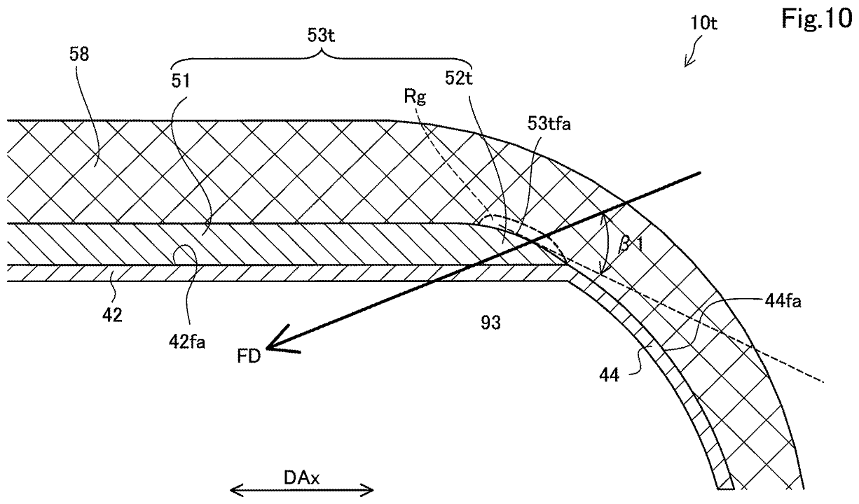

FIG. 10 is a view for explaining a tank 10t of a reference example. FIG. 10 is a view corresponding to FIG. 2. The tank 10t differs from the tank 10 of the embodiment shown in FIG. 2 in the shape of a hoop end layer 52t. The other structures are common between the tank 10t and the tank 10, so that description of the common structures will be omitted, if appropriate.

The hoop end layer 52t of the tank 10t does not project externally further in the radial direction of the body part 42 than the hoop body layer 51 but is reduced in thickness with a shorter distance from the hoop body layer 51 toward the dome part (in FIG. 10, the first dome part 44). An outer surface of the hoop end layer 52t has a curved surface shape and forms a tilted surface 53tfa tilted from the axis direction DAx. In each of the certain sections shown in FIGS. 2 and 10, the tilted surface 53tfa is tilted more gently than the tilted surface 53fa. Specifically, at each point of the axis direction DAx in each of the certain sections, a tangent to the tilted surface 53tfa and the axis direction DAx form an angle smaller than an angle formed between a tangent to the tilted surface 53fa and the axis direction DAx.

In winding the fiber bundle 80 by helical winding on the tilted surface 53tfa of the hoop end layer 52t, a winding direction FD of the fiber bundle 80 and a tangent to a portion of the hoop end layer 52t on which the fiber bundle 80 is wound form an angle β1 that is reduced considerably from 90°. Hence, in pressing the fiber bundle 80 toward the hoop end layer 52t, it is impossible in some cases to apply intended tension due to distribution of force of pressing the hoop end layer 52t with the fiber bundle 80. This reduces a degree of tight contact between the hoop end layer 52t and the helical layer 58 to cause a clearance in a region Rg between the hoop end layer 52t and the helical layer 58. This clearance may cause a void or separation between the hoop end layer 52t and the helical layer 58. The occurrence of the void or the separation reduces the strength of the tank 10t. In filling the storage chamber 25 with high-pressure fuel gas, this may cause a crack, etc. at a shoulder portion of the reinforcing layer 50 located in a boundary area between the hoop layer 53t and each of the dome parts 44 and 46 due to stress (shearing force, for example) occurring at the shoulder portion.

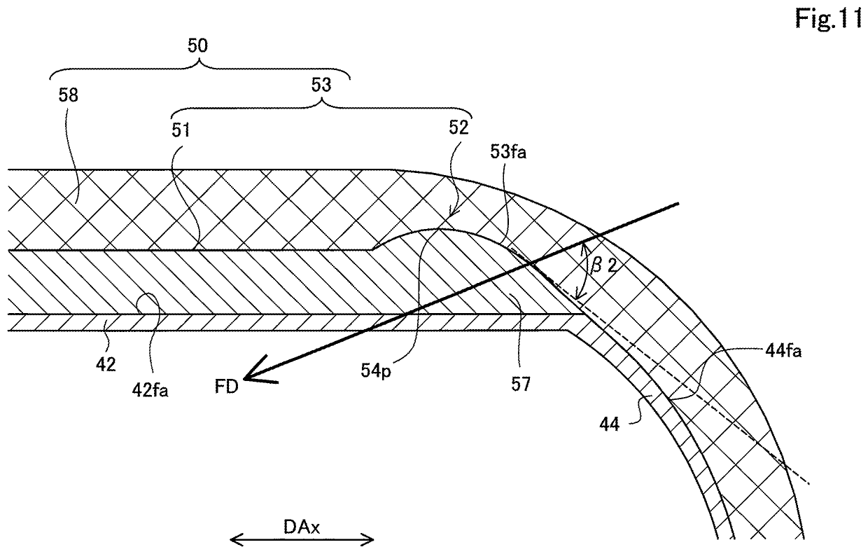

FIG. 11 is a view for explaining the helical layer forming step further. FIG. 11 is a view corresponding to FIG. 2. In winding the fiber bundle 80 by helical winding on the tilted surface 53fa of the hoop end layer 52 of the present embodiment, the winding direction FD of the fiber bundle 80 and a tangent to a portion of the hoop end layer 52 on which the fiber bundle 80 is wound form an angle β2 that is settable as an angle larger than β1 shown in FIG. 10 and more approximate to 90°. Specifically, the shape of the hoop end layer 52 projecting externally further in the radial direction than the hoop body layer 51 allows the tilted surface 53fa to be tilted more largely from the axis direction DAx than the shape of the hoop end layer 52t shown in FIG. 10 not projecting externally further in the radial direction than the hoop body layer 51. As a result, in winding the fiber bundle 80 by helical winding on the tilted surface 53fa of the hoop end layer 52, it becomes possible to suppress distribution of force of pressing the fiber bundle 80 toward the hoop end layer 52, allowing intended tension to be applied to the fiber bundle 80. This achieves an increased degree of tight contact between the helical layer 58 and the hoop layer 53 by the application of pressing force responsive to the intended tension from the fiber bundle 80 toward the hoop end layer 52, thereby reducing the probability of the occurrence of a clearance between the helical layer 58 and the hoop layer (in particular, the hoop end layer 52). Thus, it becomes possible to suppress reduction in the strength of the tank 10.

As shown in FIG. 2, according to the above-described embodiment, the tilted surface 53fa and the outer surface 44fa of the dome part 44 form an isotonic curved surface. This achieves reduction in imbalance of tension to be applied to the fiber bundle 80 of the reinforcing layer 50 formed on the tilted surface 53fa and on the outer surface 44fa, allowing the tank 10 to have strength increased to a greater degree. As shown in FIGS. 4 to 7, according to the above-described embodiment, the hoop layer 53 is formed by thermally hardening the hoop layer 63 before placement that is a cylindrical member formed by winding the sheet fiber 60 on the mandrel 70 different from the liner 40. This facilitates formation of the hoop layer 53 by using the hoop layer 63 before placement.

### B. Other Embodiments

### B-1. Another Embodiment 1

In the above-described embodiment, the hoop layer 53 is formed by thermally hardening the hoop layer 63 before placement prepared using the sheet fiber 60. However, the hoop layer 53 is not limited to this. For example, the hoop layer 53 may be formed by winding a fiber impregnated with thermosetting resin by hoop winding on the body part 42 of the liner 40. A winding direction of the fiber by hoop winding conforms to the peripheral direction of the body part 42. In forming the hoop layer 53 by hoop winding of the fiber, the hoop body layer 51 and the hoop end layer 52 may be formed by changing the number of layers to be stacked or by stacking the fiber to a certain thickness and then performing cutting or grinding in such a manner as to form the stacked fiber into the shape of the hoop layer 53.

The present disclosure is not limited to the above-described embodiments but is feasible in the form of various configurations within a range not deviating from the substance of the disclosure. For example, technical features in the embodiments corresponding to those in each of the aspects described in SUMMARY may be replaced or combined, where appropriate, with the intention of solving some or all of the aforementioned problems or achieving some or all of the aforementioned effects. Unless being described as absolute necessities in the present specification, these technical features may be deleted, where appropriate. For example, the present disclosure may be realized in the following aspects.

(1) According to a first aspect of the present disclosure, a tank for storing a fluid therein is provided. The tank comprises: a liner including a circular cylindrical body part having a center axis and a dome part placed at each of opposite ends of the body part; and a reinforcing layer placed on the liner and containing fiber. The reinforcing layer includes a hoop layer placed on the body part and a helical layer placed across an area on the hoop layer and on the dome part. The hoop layer includes a hoop body layer and a hoop end layer connected to the hoop body layer and located at an end portion in an axis direction along the center axis. The hoop end layer has a shape projecting externally further in a radial direction of the body part than the hoop body layer, and includes an apex portion located at the outermost position in the radial direction and a tilted surface extending from the apex portion toward an outer surface of the dome part and having a shape conforming to the shape of the outer surface. According to this aspect, the shape of the hoop end layer projecting externally further in the radial direction than the hoop body layer allows the tilted surface to be tilted more largely from the axis direction than the shape of the hoop end layer not projecting externally further in the radial direction than the hoop body layer. As a result, in winding the fiber by helical winding on the tilted surface of the hoop end layer, it becomes possible to suppress distribution of force of pressing the fiber toward the hoop end layer, allowing intended tension to be applied to the fiber. This achieves an increased degree of tight contact between the helical layer and the hoop layer by the application of pressing force responsive to the intended tension from the fiber toward the hoop end layer, thereby reducing the probability of the occurrence of a clearance between the helical layer and the hoop layer (in particular, the hoop end layer).

(2) In the above-described aspect, in a section defined by cutting the tank along a plane passing through the center axis and parallel to the center axis, a distance along the tilted surface may be equal to or greater than a width of a fiber bundle used for forming the helical layer. This aspect allows application of a greater amount of pressing force to the tilted surface that is responsive to intended tension applied to the fiber bundle during helical winding, thereby achieving an increased degree of tight contact between the helical layer and the hoop end layer. Thus, it becomes possible to further reduce the probability of the occurrence of a clearance between the helical layer and the hoop layer (in particular, the hoop end layer).

(3) In the above-described aspect, a distance between the apex portion and an outer surface of the body part in the radial direction may be equal to or greater than 1.05 times and equal to or less than 1.10 times the thickness of the hoop body layer. This aspect allows the tilted surface to be tilted more largely from the axis direction to a degree by which distribution of force of pressing the fiber toward the hoop end layer is suppressed during helical winding. Furthermore, a degree of external projection of the hoop end layer in the radial direction is restricted, thereby achieving reduction in the occurrence of strain on the helical layer.

(4) In the above-described aspect, the tilted surface and the outer surface of the dome part may form an isotonic curved surface. This aspect achieves reduction in imbalance of tension to be applied to the fiber of the reinforcing layer formed on the tilted surface and on the outer surface of the dome part, allowing the tank to have strength increased to a greater degree.

(5) In the above-described aspect, the hoop layer may be composed of a cylindrical member formed by winding the fiber on a member different from the liner. This aspect facilitates formation of the hoop layer by using the cylindrical member.

The present disclosure is feasible in various aspects. In addition to the above-described aspects, the present disclosure may be realized in aspects including a method of manufacturing a tank and a vehicle including the tank, for example.

What is claimed is:

1. A tank for storing a fluid therein comprising:
a liner including a circular cylindrical body part having a center axis and a dome part placed at each of opposite ends of the body part; and
a reinforcing layer placed on the liner and containing fiber, wherein
the reinforcing layer includes a hoop layer placed on the body part and a helical layer placed across an area on the hoop layer and on the dome part,
the hoop layer includes a hoop body layer and a hoop end layer connected to the hoop body layer and located at an end portion of the hoop body layer in an axis direction along the center axis, and
the hoop end layer has a shape projecting externally further in a radial direction of the body part than the hoop body layer, and includes an apex portion located at the outermost position in the radial direction and a tilted surface extending from the apex portion toward an outer surface of the dome part and having a shape conforming to the shape of the outer surface.

2. The tank according to claim 1, wherein
in a section defined by cutting the tank along a plane passing through the center axis and parallel to the center axis, a distance along the tilted surface is equal to or greater than a width of a fiber bundle used for forming the helical layer.

3. The tank according to claim 1, wherein
a distance between the apex portion and an outer surface of the body part in the radial direction is equal to or greater than 1.05 times and equal to or less than 1.10 times the thickness of the hoop body layer.

4. The tank according to claim 1, wherein
the tilted surface and the outer surface of the dome part form an isotonic curved surface.

5. The tank according to claim 1, wherein
the hoop layer is composed of a cylindrical member formed by winding the fiber on a member different from the liner.
